(19) United States
(12) Patent Application Publication
(10) Pub. No.: US 2023/0226462 A1
(43) Pub. Date: Jul. 20, 2023

(54) HYBRID THERMAL - CHROMATOGRAPHIC SYSTEM FOR SIMULTANEOUS MINERAL PURIFICATION AND DESALINATION OF SALINE WATERS

(71) Applicant: Alliance for Sustainable Energy, LLC, Golden, CO (US)

(72) Inventors: Patrick Owen SABOE, Golden, CO (US); Ryan Lane PRESTANGEN, Golden, CO (US); Eric M. KARP, Denver, CO (US); Bryan PIVOVAR, Arvada, CO (US)

(21) Appl. No.: 17/783,716

(22) PCT Filed: Dec. 9, 2020
(86) PCT No.: PCT/US20/64128

§ 371 Date: Jun. 9, 2022

Related U.S. Application Data
(60) Provisional application No. 62/945,638, filed on Dec. 9, 2019.

(51) Int. Cl. B01D 15/18; B01D 15/36; C02F 1/42

(52) U.S. Cl. CPC B01D 15/1821; B01D 15/364; C02F 1/42; C02F 2103/08

(57) ABSTRACT

Embodiments of the hybrid thermal-chromatograph systems described herein solve the co-product generation problem associated with seawater desalination, and result in significant reduction in the selling price of fresh water generated through the process, while also solving problems associated with traditional lithium mining practices.

### CROSS-REFERENCE TO RELATED APPLICATIONS

This application is a national phase entry under 35 U.S.C. § 371 and claims priority to PCT application number PCTUS2020064128 filed 9 Dec. 2020 which claims priority under 35 U.S.C. § 119 to U.S. provisional patent application No. 62/945,638 filed on 9 Dec. 2019, the contents of which are hereby incorporated in their entirety.

### CONTRACTUAL ORIGIN

The United States Government has rights in this disclosure under Contract No. DE-AC36-08G028308 between the United States Department of Energy and Alliance for Sustainable Energy, LLC, the Manager and Operator of the National Renewable Energy Laboratory. This invention was made with government support under grant no. DE-AC36-08G028308 awarded by the Department of Energy. The government has certain rights in the invention.

### BACKGROUND

Most current approaches to recovering magnesium from seawater operate via conventional hydrometallurgical chemistry with targeted chemical precipitation is used as a means for selective separation of an insoluble magnesium salt. These selective precipitation approaches use added chemicals which increase cost and environmental footprint of the system and require large fresh-water usage due to the need to wash the precipitates that are formed. Other methods use exotic electrochemical methods that are not scalable and require large energy footprints if scaled to commodity level. To date none of these electrochemical approaches have seen commercial success at large scales needed for desalination operations.

Desalination is becoming a critical technology for mankind to meet the growing fresh water demands faced by climate change, economic, and population growth. Today, Reverse Osmosis (RO) is the state of technology, producing fresh water from saline feeds at a price point of about $1.00/m³. During plentiful years, runoff water from irrigation ditches can cost as little as about 0.08/m³, making desalinated water about 10 times more expensive than runoff water. The United Nations sets a target for desalinated water of about $0.25/m³, and the current RO technology is thus about 4× more expensive than where it needs to be to supply fresh water without resulting in significant economic disruption.

Existing methods and technologies for mining elements and salts of interest from brines and saltwater are expensive, are not robust, pollute the environment, are energy intensive and some only work on small scales. As an example, the current technology used for Salar mining consists of pumping underground brine rich in a target salt (e.g. LiCl) into open shallow ponds. Solar irradiation and strong winds concentrate this brine over a period of 10 months to 2 years into solutions containing greater than 5-6 wt % of LiCl. During evaporation KCl*MgCl₂·6H₂O and MgCl₂·6H₂O precipitate if Mg is present in the brine. This precipitation reduces LiCl yields by trapping some LiCl in the precipitate. Next lime is added to precipitate any additional Mg as Mg(OH)₂—CaSO₄*2H₂O this again lowers the LiCl yield by trapping some LiCl in the magnesium precipitate. Then The aqueous LiCl is filtered off and a carbonation step is employed using the addition of soda ash to precipitate battery grade Li₂CO₃ at about 90° C. This process is the standard hydrometallurgy approach to separating Li₂CO₃ from Salars and has an overall yield of about 50 to 70% depending on the magnesium to lithium ratio.

If the Mg:Li ratio is greater than 6:1 this approach is uneconomical because the yields of Li₂CO₃ become low and large amounts of lime are needed which is not feasible economically to transport into some of these remote areas. Additionally, the approach requires a large water footprint due to the need to wash the precipitates after filtering.

Another commonly used approach to mine elements and minerals of interest from brines or saltwater is the use of ion exchange materials. These adsorbents are designed to selectively bind to Li⁺ cations directly from the saline feed. Common ion exchange materials include spinel based Li—Mn—O oxides, Li—Ti—O oxides, and LiCl*₂Al(OH)₃ oxides. These adsorbents are different than standard ion exchange resins because their mode of operation consists of selective ion bonding of Li⁺ into the oxide structure rather than non-specific ion exchange that occurs on functionalized ion exchange resins. These materials allow the separation and recovery of Li from high Mg concentration brines and from lower concentration brines (<200 ppm of Li⁺). However, shortcomings of adsorption technology include the use of strong HCl solution used in the desorption process which is an added expensive chemical requirement, and this degrades the adsorbent over time. Additionally, a very large water footprint is required to rinse the adsorbent oxides after desorption with HCl. This is a challenging requirement to meet in the high alpine Salars of South America because fresh water is difficult to transport to these remote locations.

Other technologies have been investigated at the laboratory scale including membrane recovery, electrochemical methods, and liquid-liquid extraction. These methods are not yet suitable for application at scale. Membranes do not currently have the high selectivities required for pure Li⁺ recovery and fouling requires expensive replacements. Electrochemical methods, while highly selective, are not well suited for application at scale and are considered exotic by the mining industry. Liquid-liquid extraction requires the use of expensive organic extractants whose replacement is expensive, and there is a lack of efficient processes for the recovery of Li from the organic phase once extracted.

As another example of the lack of efficient and environmentally sustainable processes used to mine elements and salts from brines and saltwater is the mining of magnesium from saltwater. Most current approaches to recovering magnesium from seawater operate via conventional hydrometallurgical chemistry with targeted chemical precipitation is used as a means for selective separation of an insoluble magnesium salt. These selective precipitation approaches use added chemicals which increase cost and environmental footprint of the system and require large fresh-water usage due to the need to wash the precipitates that are formed. Other methods employ the use of exotic electrochemical methods that are not scalable and require large energy footprints if scaled to commodity level. To date none of these electrochemical approaches have seen commercial success at large scales needed for desalination operations.

### SUMMARY

In an aspect, disclosed herein is a method for the separation of salts from an aqueous solution comprising the use of SMB chromatography comprising the use of zwitterionic resins. In an embodiment, the method comprises the production of water. In an embodiment, the method includes the isolation of salts from an aqueous solution and isolating pure water by using multi-effect distillation (MED), MED and Mechanical Vapor Recompression (MED-MVR), Plug Flow RO (PF-RO), and state of the art Closed Circuit RO (CC-RO) methods.

### BRIEF DESCRIPTION OF FIGURES

FIG. 1 depicts an overview of an embodiment of a hybrid thermal-chromatographic system for the simultaneous fractionation and purification of salts and the recovery of purified water as disclosed herein.

FIG. 2A depicts a generalized synthesis method for producing quaternary ammonium (QA⁺) cations coupled to various anion groups such as carboxylate (CA⁻), sulfonate (SO₃⁻), and phosphonate (PO₃⁻) groups tethered to a styrene divinyl benzene (SDB) resin backbone. FIG. 2B depicts a generalized synthesis method for imidazolium cation (I⁺) coupled to the anion groups shown in the blue box at various carbon spacings.

FIG. 3A depicts in-column isotherm measurements for various mineral salts to the (QA⁺)C3(SO₃⁻) resin. FIG. 3B depicts in-column isotherm measurements for various mineral salts to the commercially available (QA⁻)(C1(CO₂) Purolite resin.

FIG. 4A depicts 2-2-2-2 SMB configuration modeled in Aspen chromatography using the isotherm values and resin characterization values from FIG. 3A. FIG. 4B depicts concentration profiles of the six mineral salts at each zone in the SMB.

### DETAILED DESCRIPTION

Disclosed herein are methods and compositions used to synthesize and use novel zwitterionic chromatographic resins for the separation and purification of lithium and other salts from unconventional resources (e.g., geothermal brines and oil and gas formation waters). Embodiments of the hybrid thermal-chromatograph systems described herein solve the co-product generation problem associated with seawater desalination, and result in significant reduction in the selling price of fresh water generated through the process, while also solving problems associated with traditional lithium mining practices. Specifically, the systems and methods disclosed herein separate individual ions from saline solution using only water as an eluent. When fractions are continuously collected in a simulated moving bed (SMB) format, the purified salts are recovered through heat integrated water removal technology (e.g. multi-effect distillation (MED) or mechanical vapor recompression (MVR)).

Without being limited by theory, zwitterionic chromatography operates by whole salts intercalating between the positive and negative charges on zwitterions tethered to a resin backbone. As a mixed-salt solution (brine) moves downward through the column, individual salts separate from one another based on their differing affinities with the stationary-phase zwitterion. For example, LiCl is a small, charge-dense salt that has minimal interaction with the stationary-phase zwitterion, but MgCl₂ has a divalent charge with a greater interaction with the stationary-phase zwitterion and is thus slowed to a greater extent than LiCl as it moves down through the column. These differing interactions that salts have with the stationary-phase zwitterion are the driving force for their separation. The stationary-phase zwitterion can be tuned to achieve maximum separation (resolution) of LiCl from the other salts. Compared to traditional IX used in direct lithium extraction (DLE) zwitterionic chromatography requires no addition of mineral acid, reducing OPEX; has greater throughput because it can be run continuously; and has the potential to separate many types of valuable mineral salts, for example LiCl. When separation factors (generally >1.5) are achieved for LiCl from the other salts in a batch column experiment, then the process can be scaled in an SMB.

In contrast to conventional ion exchange (IX), zwitterionic chromatography operates chromatographically using only water as the eluent and thus requires no added chemicals. This improves environmental stewardship and decreases operating expenses (OPEX) compared to currently practiced DLE technology. Additionally, an increase in resin lifetime is demonstrated herein because mineral acids—which often reduce resin durability—are not used. Increased throughput and increased yields using zwitterionic chromatographic methods and compositions disclosed herein are also demonstrated. In an embodiment, the zwitterionic chromatography disclosed herein is useful for mineral recovery. Zwitterionic chromatography methods and compositions disclosed herein are useful to fractionate not just LiCl, but many mineral salts simultaneously (e.g., MnCl₂, CoCl₂) that may also be present in the input brine. This allows a more universal stationary phase for the recovery of minerals from saline resources simply by changing the switching sequence of the SMB, which can be done on the fly with the SMB software. In contrast, IX technology packs the columns with adsorbent specifically designed to selectively remove a single cation (e.g., Li⁺). If the operator wishes to recover a different mineral in the resource (e.g., Co₂⁺), a new process with different adsorbent is used using methods and compositions disclosed herein.

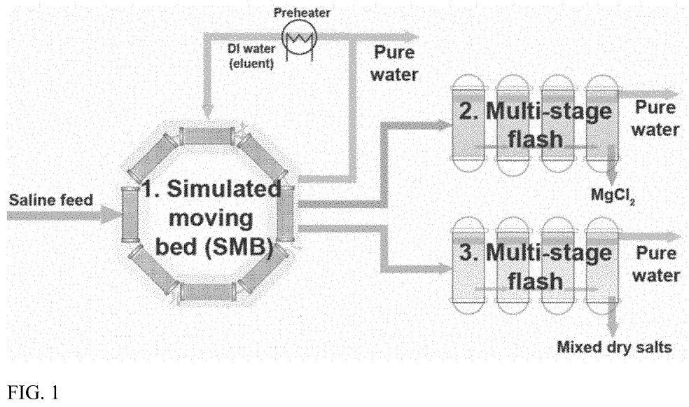

In an embodiment, the method disclosed herein consists of a process that receives seawater or other brine solutions as a feed and chromatographically fractionates the dissolved ionic compounds into purified fractions. The fractions consist of a pure water cut, and mixed salt cuts that each consist of single ionic pair compound dissolved in water, and, potentially, a mixed ionic component fraction. In an embodiment, the eluent used in the chromatographic separation is fresh water which increases the sustainability and scalability of this process. In post-chromatographic fractionation, water is removed from each saline fraction via a thermal process such as multistage flash, mechanical vapor recompression, and/or multi-effect distillation. This leaves purified dry salts and fresh desalinated water as products. FIG. 1 depicts an embodiment of this process. Purified metals can then be recovered from the dry salts via known technology such as electrowinning.

The present disclosure may address one or more of the problems and deficiencies of the prior art discussed above. In an embodiment, using methods disclosed herein various elements, minerals and salts including the following, for example, can be separated efficiently from salt water, brine or any aqueous solution: cobalt, lithium, magnesium, rare earth elements group, strontium, tin, tungsten, zirconium. In an embodiment the rare earth elements group consists of cerium, dysprosium, erbium, europium, gadolinium, holmium, lanthanum, lutetium, neodymium, praseodymium, promethium, samarium, scandium, terbium, thulium, ytterbium, and yttrium. In an embodiment, a zwitterionic stationary phase is synthesized and scaled, able to handle very hard resource waters, and it is capable of fractionating many minerals salts simultaneously, allowing flexibility in mineral recovery targets.

Using methods disclosed herein, improvements over existing desalination or elemental harvesting include a reduced CO₂ footprint, reduced consumption of chemicals, reduced waste generation, and reduced energy demand.

In an embodiment, methods for development and synthesis of new zwitterionic ion exchange materials are disclosed herein. In an embodiment the zwitterionic ion exchange materials are packed, characterized, and tested at both small and large scale and are further mathematically modeled in an SMB system in Aspen Chromatography using determined resin and column parameters. Disclosed herein are methods for material performance and selection for a multi-column system setup in an 8, 16 or more, column SMB system.

In an embodiment, the chromatographic fractionation step is performed using a zwitterionic (a.k.a. amphoteric) resin that interacts with the entire ionic compound as it moves through the column. A benefit of the zwitterionic media is that the eluent used is pure water rather than a buffered solution commonly used in ion chromatography approaches. This differs from zwitterionic chromatography used in embodiments disclosed herein that is sometimes referred to as “ion pair” chromatography or extraction chromatography of ionic compounds.

The methods and embodiments disclosed herein allow some or all of the pure-water cut obtained from the SMB chromatographic separation to be recycled back to the chromatographic process for reuse as the eluent (see FIG. 1) and substantially adds to lowering the environmental footprint of the system since no waste salts are generated, which is in contrast to ion chromatography approaches that use buffered solutions as a eluent. An ionic compound such as sodium chloride (NaCl) interacts with the zwitterionic resin as it chromatographs down the column. This “ion pair” chromatographic effect allows fresh water to be used as the eluent eliminating the need for a buffered solution to be used as the eluent. The chromatographic fractionation step is scaled into a continuous process through the use of a SMB that can process thousands of cubic meters of saline water (or more) per day. The switching sequence of the SMB system can be modified to collect pure cuts of any of the ionic compounds provided their separation factors are high enough. Mixed cuts containing multiple ionic species can also be obtained by widening the collected fractions with the SMB switching sequence. Additionally, fresh-water cuts can also be collected by adjusting the switching sequence to collect fractions between the ionic peaks. Each peak position can be measured in real time using an online conductivity detector or in some cases a UV detector.

In an embodiment, the ability of the zwitterionic resins used in SMB chromatography to separate depends upon the length of the alkane or other monomeric units that make up the polymer comprising the zwitterionic chains as well as the nature, identity and number of ionic species that make the resins zwitterionic. For example, and without being limiting, the zwitterionic groups may include phosphate, quaternary amines, amides, carboxylic acids, amines and other functional groups which may be ionized at various aqueous pH ranges.

In and embodiment, disclosed herein are zwitterionic resins useful in SMB chromatography with different zwitterionic functional groups made using different synthesis methods. In an embodiment, zwitterionic resins were developed for 2% cross-linked polystyrene divinylbenzene resin (200-400 mesh). In an embodiment, the functional group of the zwitterionic resins are quaternary amine—1 carbon linkage—carboxylate (R—N+(CH₂)₂—CH₂—COO⁻). In an embodiment, the functional group of the zwitterionic resins are quaternary amine—3 Carbon linkage—carboxylate (R—N+(CH₂)₂—(CH₂)₃—COO⁻). In an embodiment, the functional group of the zwitterionic resins are quaternary amine—3 Carbon linkage—Sulfonate (R—N⁺(CH₂)₂—(CH₂)₃—SOOO⁻)-QAC3SA. In an embodiment, the functional group of the zwitterionic resins are imidazolium—1 carbon linkage—carboxylate (R—N₂⁺(CH₂)₃—CH₂—COO⁻)—IMC1CA.

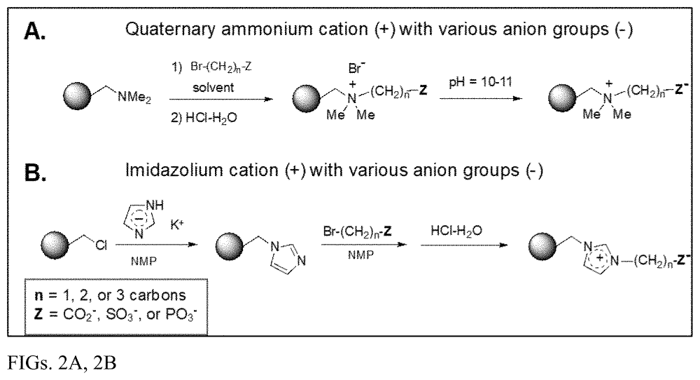

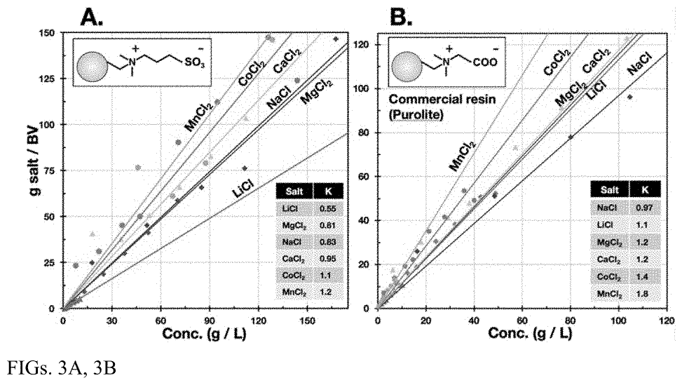

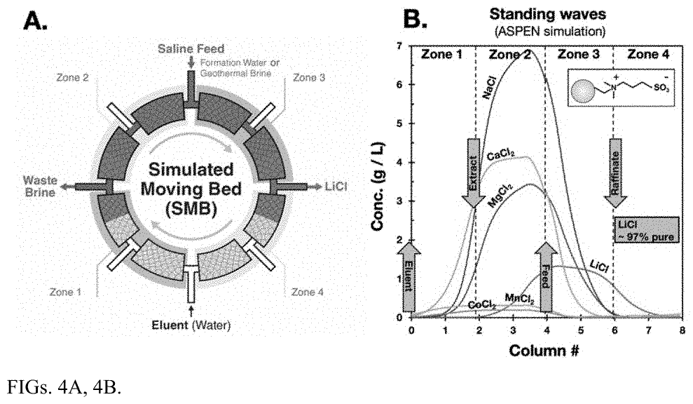

Synthesis methods are described herein and, in an embodiment, in FIG. 2. Approximately 20 g of each of these functionalized resins have been produced on a backbone sourced from NetQem, LLC. In addition, approximately 20 g of three of these resins have been produced on a backbone sourced from Sigma Aldrich. Resin characterization methods include particle size analysis, elemental analysis, ion exchange capacity analysis, and water uptake measurements by dynamic vapor sorption. Each resin was packed in a small column. Analytes tested include the chloride salts of lithium, magnesium, sodium, calcium, cobalt, and manganese. Column characterization methods include equilibrium isotherm testing, void volume measurements, and analyte retention measurements. Equilibrium isotherm measurements are shown in FIG. 3. Single column modelling and SMB modelling is performed in Aspen Chromatography. The single column models are used to determine size exclusion and intra-particle diffusivity parameters for each analyte. The standing wave design theory for SMB design is used to estimate the operating conditions and port switching sequence for the SMB simulation. The SMB simulation results in predicting system productivity, raffinate and extract port profiles, and the standing wave design profile at steady state. Standing wave plots are shown in FIG. 4.

Disclosed herein are robust and scalable synthesis procedures to produce preparative quantities of zwitterionic resins. FIG. 2A shows the general synthesis method for quaternary ammonium (QA+) cations connected to various anions such as a carboxylate (CA−) group, sulfonate (SO₃—) group, or phosphonate (P—) group. The chemistry for this synthesis reacts a weakly basic dimethylamino styrene divinyl benzene (SDB) resin with brominated intermediates in an alcohol solvent. The brominated intermediates take the form of Br—(CH₂)n-Z, where N is 1, 2, or 3 and Z is one of the anion groups listed above. This reaction takes approximately 3-12 hours (dependent on the Z group) at 90° C. and produces the QA+ zwitterionic resin functionalized with the Z group in its ester form.13 Then, HCl and water at pH<3 is added to liberate the alcohol ester and form the acidic Z group. However, because the pH of the solution is less than 3, the anion on the resin is in its protonated form. Thus, the final step is raising the pH to 10-11 with the addition of NaOH. This produces the QA+ and Z— zwitterionic resin. The resin is then filtered from the solution, washed with water, and placed in a 40° C. vacuum oven for 24 hours to produce a dry resin that can then be used to pack into columns and used in a SMB system. To synthesize the zwitterionic resins with imidazolium (I+) cations connected to CA−, SO₃—, or P— anion groups, a chloromethylated SDB resin is used as the starting material. The chloromethylated SDB is reacted with potassium imidazolide in N-methyl-2-pyrrolidone (NMP) at room temperature to produce the SDB resin functionalized with imidazolide (FIG. 2B). Then the brominated intermediate, Br—(CH₂)n-Z, is added, followed by acidification with the addition of water and HCl in the same way as described previously for the QA+ zwitterion synthesis. This yields the imidazolium cation (I+) tethered to various anion groups at carbon spacings dictated by the brominated intermediate used (FIG. 2B).

The synthetic approaches depicted in FIG. 2 allow for the production of multiple zwitterionic resins. The synthetic methods disclosed and used herein are very scalable, and can be used to produce, in an example, greater than 5 kg of resin. In an embodiment, the dimethylamino SDB resin and the chlorinated version starting materials may be purchased in bulk. Additionally, they be purchased with a variety of mesh sizes (particle diameters) and pore sizes. In an embodiment, the resins have 40-80-μm diameters. In an embodiment resins of these diameters are able to minimize bandspreading during batch chromatography while maintaining a pressure of about 4 bar, which is below the 5-bar limit for general SMB equipment.

In an embodiment, after being synthesized using methods disclosed herein, the zwitterionic resins are then packed into columns for batch chromatography experiments to measure pore size and equilibrium adsorption isotherms for mineral salts of interest. Pore size measurements are made “in column,” where pulses of undyed Dextran 2000 are passed through the bed. The Dextran 2000 pulse allows the measurement of the void space between the resin beads in the column because Dextran 2000 is too large to enter the pores of the resin. Next, the total porosity of the column is measured by pulsing D₂O through the column, which can enter both the pores and the void space. The particle porosity can then be back calculated from these two measurements. The particle porosity is useful measurement for SMB modeling work and it also varies significantly as zwitterion chain length increases (see FIG. 2) because the longer zwitterionic groups crowd the pores and effectively shrink their size. Smaller pores can generate a secondary “sieving” effect of ions that may increase their resolution, but if they are too small then ions are excluded from entering them. Lastly, “in-column” isotherms are measurements made to quantify the differences in affinity for different minerals to the zwitterionic resins. These measurements are made through standard procedures and provide a driving force for resolution of minerals from one another.

FIG. 3 displays equilibrium adsorption isotherm results of synthesized (QA⁺)C3(SO₃—) zwitterionic resin (see FIG. 3A) compared to the only commercial zwitterionic resin available—a (QA+)C1(CA−) material from Purolite (WCA100 resin) (see FIG. 3B). Both resins had measured functional group densities of 3-3.7 mEq/g. The slopes of the lines in FIG. 3 are the equilibrium constants for each mineral salt. The resin synthesized using methods and compositions disclosed herein is able to resolve MnCl₂, CoCl₂, CaCl₂), and LiCl from a mixed brine due to the differences in equilibrium adsorption constants. This is in contrast to the commercial (QA⁺)C1(CA⁻) resin, which is not capable of resolving LiCl from MgCl₂ or CaCl₂). The results depicted in FIG. 3 demonstrate that the materials disclosed herein are capable of separating minerals (namely LiCl) from brines at a level of fidelity that commercially available materials cannot achieve. In an embodiment, the optimum spacing between charge groups for maximum salt separation is C2 based on the hydrated ion sizes, and thus the level of separation shown in FIG. 3A can be improved even further.

In an embodiment, greater than 15 g of 18 different zwitterionic resins (such as those depicted in FIG. 2) can be synthesized to test for mineral separation in batch mode. In an embodiment, these resins are QA+ and CA− functional group resins tethered to an SDB backbone separated by 1, 2, and 3 carbons; QA+ and P— functional groups separated by 1, 2, and 3 carbons; and QA+ and SO₃— functional groups separated by 1, 2, and 3 carbons using synthesis methods as disclosed herein, see, for example, FIG. 2.

In an embodiment, the resins synthesized using methods disclosed herein can be used to make gram and kilogram quantities of each of QAC1CA, QAC2CA, QAC3CA, QAC1PO₃, QAC2PO₃, QAC3PO₃, QAC1SO₃, QAC2SO₃, and QAC3SO₃ resins.

In an embodiment, the resins synthesized using methods disclosed herein can be used to make gram and kilogram quantities of each of IC1CA, IC2CA, IC3CA, IC1PO₃, IC2PO₃, IC3PO₃, IC1SO₃, IC2SO₃, and IC3SO₃ resins.

In an embodiment, the characterization of the synthesized resins can be performed to determine functional site density through reaction synthesis mass yields, CHN analysis, and IEC measurements. Pore size measurements of the synthesized resins can be performed by using Brunauer-Emmett-Teller (BET) isotherms, swelling tests, and tracer pulse tests in batch mode.

In an embodiment, the IEC, CHN analysis, and reaction synthesis mass yields for the resins made using methods disclosed herein result in metrics for bed porosity and estimated pore size from tracer study using D2O and Dextran 2000 as tracers, BET measurements, and/or swelling tests.

In another embodiment, match testing with model salt solutions can be performed to determine resin K_{D} values for LiCl, CoCl₂, MgCl₂, MnCl₂, and at least one other dominate mineral present in samples. In an embodiment, the separation in K_{D} must be large enough to generate separation factors >1 LiCl and CoCl₂ from divalent ions. In an embodiment, bed porosities are greater than 0.35.

In an embodiment, the zwitterionic resins disclosed herein have a half-life of at least 2 years at 90° C. operating temperatures.

The ability to separate LiCl, MnCl₂ and CoCl₂ simultaneously using methods and compositions of matter disclosed herein is depicted in FIG. 3A and demonstrates the capability of the resins and methods to be used for the recovery of many different minerals from a saline resource. This is in contrast to IX technology in which stationary phases are specially designed to adsorb a single cation. For example, in DLE, IX resins such as aluminum compounds, spinel-type manganese-oxide-based adsorbents, and modified cation-exchange resins are used and can only be used for recovery of Li+. The zwitterionic resins and methods of use disclosed herein can be used to separate many salts simultaneously from brines that results in mineral recovery.

In an embodiment, the isotherm results depicted in FIG. 3 and characterization data are used to build a full-scale model of a continuous SMB process in the Aspen chromatography package to predict critical parameters such as yield, purity, and throughput needed for techno-economic analysis (TEA) and for benchmarking this technology to DLE. This model is also used to predict a switching sequence that will be used for continuous SMB demonstration runs. The Aspen simulation solves a complex set of coupled partial differential equations that account for equilibrium interactions and mass transfer effects down the column and it requires the input of particle porosity, radius, and equilibrium constants for all components in the feed, as well as the column geometry. The equations are increasingly difficult to solve as the number of components in the feed increases and as the zone configuration increases in complexity. The system was solved for all six components in FIG. 3A for the (QA+)C3(SO₃—) zwitterionic resin using the measured values to generate a switching sequence for continuous LiCl recovery. The results of this simulation are depicted in FIG. 4 where standing waves for all salts are produced. This is beneficial for the SMB to work at large scales. LiCl produces a standing wave that comes out first at a purity of about 97% in a standard 2-2-2-2 column configuration. The simulation results from Aspen chromatography in FIG. 4 assume a basic SMB setup that can result in greater than 99% purity by solving this system for SMB configurations with additional columns in each zone. In an embodiment, a 3-3-3-3 column configuration can be used to get greater than 99% purity.

FIG. 4B also depicts an advantage of the zwitterionic chromatographic technology disclosed herein compared to conventional IX in handling hard minerals: high concentrations of hard minerals such as CaCl₂) and MgCl₂ are separated from LiCl without fouling the resin. Without being limited by theory, this is because the zwitterion does not bind or chelate the 2+ ions as some IX resins do, but these ions still exhibit a greater interaction with the zwitterion than LiCl, slowing them at a greater rate.

In DLE, IX resins selectively adsorb Li+ ions that must be eluted from the column with hydrochloric acid, and that acid is an added chemical cost that also reduces resin lifetimes and must be remediated at an additional cost. In contrast, the zwitterionic SMB operates chromatographically using only water as the eluent and thus requires no added chemicals and increases throughput. This improves environmental stewardship and reduces OPEX.

Additionally, the data depicted in FIG. 4 demonstrate that this resins and methods disclosed herein have the ability to withstand and be used in saline waters with concentrations of hard minerals above what IX can handle. Thus, in an embodiment, very hard resource waters for LiCl extraction may be used to isolate LiCl. As an example, water in the Bryans Mill, Tex., area contains about 2.5 g/L of LiCl but also contains 78 g/L of CaCl₂) and 11 g/L of MgCl₂. The level of hardness of this resource is so great that current DLE technology cannot exploit it for LiCl recovery. However, zwitterionic chromatography methods and compositions disclosed herein could be used for LiCl recovery.

In an embodiment, the lifetime of the resins disclosed herein have a lifetime of about 8 to 10 years. Most IX resins used in DLE have a lifetime of about 5-8 years. In another embodiment, the zwitterionic materials disclosed herein could have a lifetime of 8-10 years because no mineral acid is used that has a tendency to degrade IX materials and the operating conditions using methods disclosed herein are mild, using only water as the eluent at room temperature and pressures less than 5 bar.

Advantageous properties of the zwitterionic resins used in chromatography as disclosed herein are depicted in Table 1.

TABLE 1
Metrics for zwitterionic chromatography
technology baselined to DLE.

| | | Zwitterionic |
|---|---|---|
| Metric | DLE (Baseline) | Chromatography |
| LiCl productivity | ~0.3 min⁻¹ | >0.1 min⁻¹ |
| | | (factor of >1.5) |
| LiCl yield (single pass) | 70%-90% | >90% |
| LiCl purity (single pass) | ~80% | >99% |
| OPEX (IX) | ~$5.07/ton of brine | >30% reduction |
| Resin lifetime | 4-8 years | >5 years |

In an embodiment, the zwitterionic SMB systems disclosed herein can be used to process a minimum of 20 gallons of water containing LiCl to obtain greater than 100 g of purified LiCl from the continuous SMB.

In another embodiment, LiCl is purified from brine using the novel zwitterionic resins and chromatography disclosed herein and can produce a continuous, high purity (>97% LiCl) product stream. In an embodiment, a 16-column)(Pure SMB system and a Cytiva Akta Pure 25 system are used with the zwitterionic resins and methods disclosed herein. In another embodiment, greater than 99% pure LiCl may be isolated from brines containing various different salts by using systems, methods and compositions disclosed herein.

In an embodiment, methods disclosed herein use SMB chromatography and zwitterionic resins that desalinate and chromatographically fractionate minerals simultaneously. SMB chromatography is different from ion exchange chromatography at least in so far as SMB chromatography uses warm water as an eluent; exhibits an entropy decrease that is driven by pressure from about 3 to about 5 bar and a temperature from about 70 to about 90° C.

The separation capabilities of resins disclosed herein are affected by resin properties including, but not limited to, the charge to distance ratio as it relates to separation factors, the ionic strength of charge centers, and the pH at which the resin is operated.

Operational parameters that affect the separation capabilities of the resins disclosed herein include the temperature, pressure and flowrates at which the resins are operated.

Advantages of using the SMB chromatographic methods disclosed herein include completely removing Mg, Na, and B using no added chemicals, at lower costs and the ability to use brines with high Mg and other ion concentrations. For example, in an embodiment, magnesium chloride salt is separated from other dissolved salts chromatographically through interaction with the zwitterionic media in a SMB using water as an eluent. Other dissolved salt can also be collected in purified fractions. As a metal, magnesium can then be recovered from the purified salt through known technology such as electrowinning.

In an embodiment, the cost associated with desalination is decreased by co-product generation of a purified metal salts to offset the cost of the desalinated water. In an embodiment, magnesium can be harvested from seawater. Magnesium chloride is present in seawater at approximate 1200 ppm and has thus been the target of many combined desalination and mining technologies to recover it as a coproduct. Magnesium metal has a value over $3000 per ton. This high price point of magnesium is currently driven by demand in the automotive sector for producing the next generation of lightweight alloys that incorporate magnesium.

In an embodiment, post-SMB chromatography relies on thermal dewatering of the separated fractions. Thermal desalination with heat integration techniques is a known approach that is cost competitive with RO technology due to the increased water yields and the current low cost of electricity. For example, Table 2 lists selling prices associated with multi-effect distillation (MED), MED and Mechanical Vapor Recompression (MED-MVR), Plug Flow RO (PF-RO), and state of the art Closed Circuit RO (CC-RO) systems. All of these commercially deployed desalination technologies produce desalinated water at a price point of about $1.00/m³. Despite state-of-the-art RO systems such as CC-RO that have very low energy consumption (about 2 kwh/m³), RO only has a 50% water yield and the current cost of electricity is relatively low making the electricity consumption of a desalination process a small driver of overall cost (see Table 2). This is an economic concern and it has been suggested that energy efficiency should not be a research focus since gains in energy efficiency to not, to a large extent, lower the selling price of the produced water.

TABLE 2

| | | Energy | Practical | |
|---|---|---|---|---|
| Desalination | Selling | consumption | energy limit | |
| tech | price ($/m³)* | (kwh/m³) | (kwh/m³) | ZLD? |
| MED | $0.88-1.16⁽²⁾ | 6.5-11⁽²⁾ | ~3 | yes |
| MED-MVC | $0.92-1.32⁽²⁾ | 6-10 | ~3 | yes |
| PF-RO | $0.99-1.09⁽²⁾ | 3-5.5^{(1,2)} | 1.1 | no |
| CC-RO | $0.90-1.07⁽³⁾ | 2.1 | 1.1 | no |

Overall, the methods disclosed herein allow for separation of any purified metal salt before a thermal dewatering step using a simulated moving bed without the consumption of any ancillary chemicals. The thermal desalination step does not add significant cost to the system as shown in Table 2 and discussed above in the context of desalination. An advantage of embodiments as disclosed herein is the production of a coproduct salt that significantly adds value and thus lowers the overall selling price associated with the produced fresh water. SMB technology is scalable and when designed with the ion pairing chromatography approach disclosed herein allows for a massively scalable and economical approach to fractionation whole ionic compounds from saline feeds using no added chemicals. Furthermore, the methods disclosed herein allows for mining of saline feeds, in general, for valuable metal salts using only water and thermal energy as an input. This approach significantly lowers the overall economic footprint of the system compared to traditional hydrometallurgical and ion exchange approaches for saline water mining and is likely to be far greener than conventional strip-mining approaches for metals derived from ores.

The foregoing discussion and examples have been presented for purposes of illustration and description. The foregoing is not intended to limit the aspects, embodiments, or configurations to the form or forms disclosed herein. In the foregoing detailed description for example, various features of the aspects, embodiments, or configurations are grouped together in one or more embodiments, configurations, or aspects for the purpose of streamlining the disclosure. The features of the aspects, embodiments, or configurations may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

What is claimed is:

1. A method for the separation of salts from an aqueous solution comprising the steps of using simulated moving bed (SMB) chromatography and the use of zwitterionic resins.

2. The method of claim 1 wherein the salts comprise different salts.

3. The method of claim 2 wherein the different salts are separated from each other.

4. The method of claim 3 wherein the salts comprise LiCl.

5. The method of claim 3 wherein the salts comprise LiCl, CaCl₂ and MgCl₂.

6. The method of claim 1 wherein the zwitterionic resins comprise quaternary ammonium cations.

7. The method of claim 1 wherein the zwitterionic resins comprise imidazolium cations.

8. The method of claim 1 wherein the zwitterionic resins comprise anions selected from the group consisting of CO₂, SO₃ and PO₃.

9. The method of claim 1 wherein the zwitterionic resins are selected from the group consisting of QAC1CA, QAC2CA, QAC3CA, QAC1PO₃, QAC2PO₃, QAC3PO₃, QAC1SO₃, QAC2SO₃, and QAC3SO₃.

10. The method of claim 1 wherein the zwitterionic resins are selected from the group consisting of IC1CA, IC2CA, IC3CA, IC1PO₃, IC2PO₃, IC3PO₃, IC1SO₃, IC2SO₃, and IC3SO₃.

11. A method for the isolation of salt free water from a salt containing solution comprising the separation of salts from the salt containing solution comprising the steps of using simulated moving bed (SMB) chromatography and the use of zwitterionic resins.

12. The method of claim 11 wherein the zwitterionic resins comprise quaternary ammonium cations.

13. The method of claim 11 wherein the zwitterionic resins comprise imidazolium cations.

14. The method of claim 11 wherein the zwitterionic resins comprise anions selected from the group consisting of CO₂, SO₃ and PO₃.

15. The method of claim 11 wherein the zwitterionic resins are selected from the group consisting of QAC1CA, QAC2CA, QAC3CA, QAC1PO₃, QAC2PO₃, QAC3PO₃, QAC1SO₃, QAC2SO₃, and QAC3SO₃.

16. The method of claim 11 wherein the zwitterionic resins are selected from the group consisting of IC1CA, IC2CA, IC3CA, IC1PO₃, IC2PO₃, IC3PO₃, IC1SO₃, IC2SO₃, and IC3SO₃.

17. A composition of matter comprising zwitterionic resins comprising quaternary ammonium cations, imidazolium cations and further comprising anions.

18. The composition of matter of claim 17 comprising zwitterionic resins comprising anions selected from the group consisting of CO₂, SO₃ and PO₃.

19. The composition of matter of claim 17 comprising zwitterionic resins selected from the group consisting of QAC1CA, QAC2CA, QAC3CA, QAC1PO₃, QAC2PO₃, QAC3PO₃, QAC1SO₃, QAC2SO₃, and QAC3SO₃.

20. The composition of matter of claim 17 comprising zwitterionic resins are selected from the group consisting of IC1CA, IC2CA, IC3CA, IC1PO₃, IC2PO₃, IC3PO₃, IC1SO₃, IC2SO₃, and IC3SO₃.
